(19) United States
(12) Patent Application Publication
(10) Pub. No.: US 2009/0077371 A1
(43) Pub. Date: Mar. 19, 2009

(54) SYSTEMS AND METHODS FOR A TEMPLATE-BASED ENCRYPTION MANAGEMENT SYSTEM

(75) Inventors: Gregory Alan Powell, Ladera Ranch, CA (US); Jason James Dorsey, Mission Viejo, CA (US); Dean Edward McKee, Irvine, CA (US); Joachim Patrick Vance, Arroyo Grande, CA (US); Erik Scott Schetina, Queens, NY (US)

Correspondence Address: KNOBBE MARTENS OLSON & BEAR LLP, 2040 MAIN STREET, FOURTEENTH FLOOR, IRVINE, CA, 92614, US

(73) Assignee: VALICORE TECHNOLOGIES, INC., Irvine, CA (US)

(21) Appl. No.: 12/209,033

(22) Filed: Sep. 11, 2008

Related U.S. Application Data
(60) Provisional application No. 60/972,697, filed on Sep. 14, 2007.

(51) Int. Cl. H04L 9/28; H04L 9/00

(52) U.S. Cl. 713/152; 380/278

(57) ABSTRACT

An encryption management system provides a solution for embedded system device authentication, secure server-to-device communications, and encryption key management. It reduces implementation times and costs associated with using cryptography for authentication and data privacy with embedded systems applications by freeing application developers from having to develop, manage, or update security-based features in their server-based applications. The template-based approach of the system provides highly customable and accessible security functionalities. To utilize services provided by the encryption management system in some embodiments, calling applications provide input parameters and function calls in the form of a template at runtime, and the output in the form of encrypted and secured messages are either sent to the client devices automatically or returned to the calling applications. As such, security functionalities and objects, though segregated in the encryption management system to provide enhanced protection, can still be easily accessed and can be updated without recompiling the calling applications.

### CROSS-REFERENCE TO RELATED APPLICATIONS

This application claims priority to U.S. Provisional Patent Application No. 60/972,697 filed on Sep. 14, 2007, entitled “Systems and Methods for Template-Based Encryption,” the entire contents of which are hereby incorporated herein by reference in their entirety. All publications and patent applications mentioned in this specification are herein incorporated by reference in their entirety to the same extent as if each individual publication or patent application was specifically and individually indicated to be incorporated by reference.

### BACKGROUND

1. Technical Field

The present invention relates to encryption systems, and more specifically, to template-based encryption management systems that provide encryption and secured messaging services to server-based applications.

2. Description of the Related Art

A large number of electronic transactions take place over the Internet, and security is a primary concern for sensitive data transmitted as part of these electronic transactions. Software developers who develop systems and applications that handle these sensitive transactions often either develop their own encryption and authentication subsystems or rely on standard packages commonly found in various programming languages. However, neither method is ideal. First, as data encryption is a complex and ever-evolving area of technology, software developers who develop their own encryption sub-systems often face the daunting task of trying to become experts in this specialized area. Second, those developers who rely on standard packages may be inadvertently relying on insecure or inherently weak encryption methods. Worst yet, neither method provides the flexibility to easily update the required encryption functionalities should an underlying encryption method prove to be insecure or should the sensitive data require stronger encryption guarantees. Even if software developers could integrate security sub-systems into their applications, they must expend substantial time and effort, thus driving up costs.

### SUMMARY

Disclosed herein is a template-based encryption management system that manages, enforces, and supports secure communication between a server-based application and one or more client devices. The template-based encryption management system handles the secure communication and management needs of server-based applications and frees the application developers from having to develop, manage, or update security features in their server-based applications. The template-based approach provide a highly customable and accessible way for these applications to access security functionalities and features for the purpose of securely communicating to their network of client devices. To utilize services provided by the encryption management system, the calling applications provide input parameters and data in the form of a text-based template at runtime, and output in the form of encrypted and secured messages are either sent to the client devices automatically or returned to the calling applications.

In one embodiment, the encryption management system provides a security boundary within which cryptographic keys and other sensitive data used to secure the communication are stored and protected from exposure. The boundary also limits the attack surface of sensitive data that needs to be transmitted from the server-based calling applications to the client devices. Although these security functionalities, including algorithms and keys, are segregated to provide enhanced protection, the use of templates ensures that they can still be easily accessed and updated without recompiling the calling applications. The template-based approach also enables the encryption management system to be extensible to support custom, specific cryptographic algorithms as well as custom keys needed by the calling applications.

In one embodiment, the encryption management system provides a solution for embedded system device authentication, secure server-to-device communications, and encryption key management. The encryption management system dramatically reduces implementation times and costs associated with using cryptography for authentication and data privacy with embedded systems applications. The encryption management system can be broadly deployed in any application utilizing special function terminals or embedded system devices including entertainment, manufacturing, healthcare, government, and transportation venues where device authentication and data privacy is important.

### BRIEF DESCRIPTION OF THE DRAWINGS

Preferred embodiments of the invention will now be described with reference to the drawings summarized below. These drawings and the associated description are provided to illustrate preferred embodiments of the invention, and not to limit the scope of the invention.

FIG. 1A is a block diagram showing an encryption management system according to one embodiment.

FIG. 1B is a block diagram showing a template engine according to one embodiment.

FIGS. 2A through 2D illustrate sample template operations in accordance with one embodiment.

FIG. 3 is a flow diagram of the “generate and send key” operation in accordance with one embodiment.

FIG. 4 is a block diagram illustrating the input and output data format of the “generate and send key” operation in accordance with one embodiment.

FIG. 5 is a flow diagram of the “wrap and send key” operation in accordance with one embodiment.

FIG. 6 is a flow diagram of a custom function in accordance with one embodiment.

FIG. 7 illustrates an application of the encryption management system in the manufacturing line environment in accordance with one embodiment.

FIG. 8 illustrates an application of the encryption management system in the media content distribution environment in accordance with one embodiment.

FIG. 9 illustrates the hardware and software components of the encryption management system in accordance with one embodiment.

### DETAILED DESCRIPTION OF PREFERRED EMBODIMENTS

A template-based encryption management system and associated components will now be described with reference to the drawings. Where possible, the same reference numbers are used throughout the drawings to refer to the same or like components. This description is intended to illustrate certain preferred embodiments, but other embodiments that are apparent to those of ordinary skill in the art, including embodiments which do not provide all of the benefits and features set forth herein, are also within the scope of this invention. As one example, some embodiments may omit some or all of the security features described herein. Thus, nothing in this detailed description is intended to suggest that any particular feature or component is essential. The invention is defined by the claims.

### 1. APPLICATION ENVIRONMENT

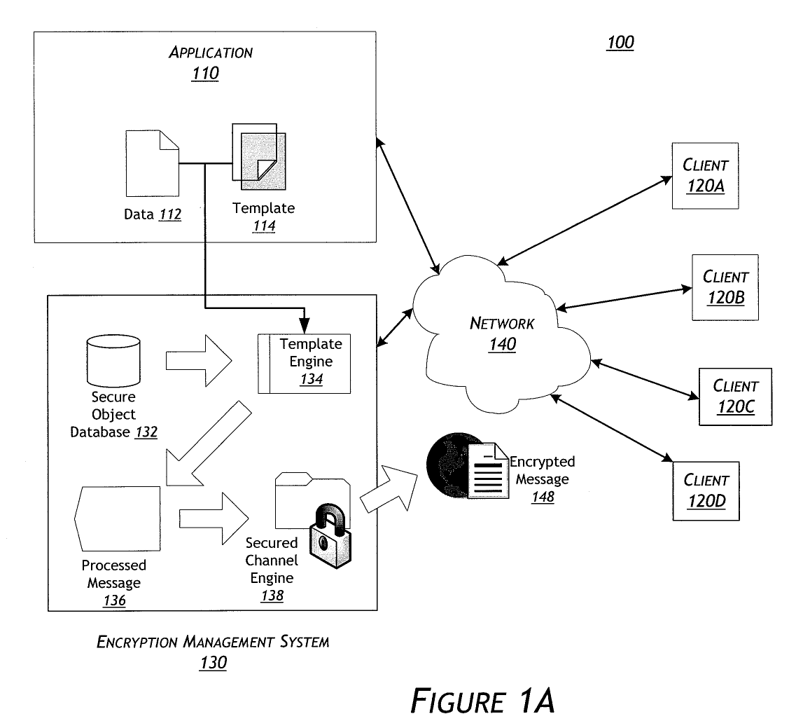

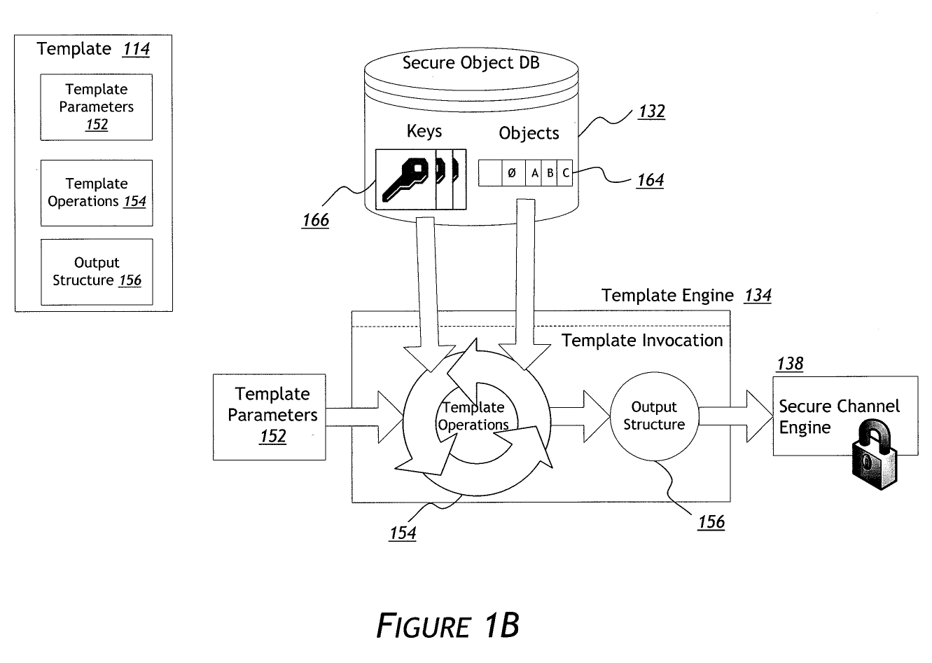

FIG. 1A is a block diagram showing a sample data flow of the encryption management system and a sample application environment 100 for the encryption management system. Shown in the environment 100 is an application 110 that needs to communicate securely with a number of client devices 120 (e.g., 120A, 120B, 120C, 120D, etc.). In one embodiment, data 112 needs to be securely transmitted. For example, a financial application 110 residing on a server may need to transmit sensitive financial data to a number of terminals 120 (e.g., a stock broker's mobile computer). In another example, a medical data server application 110 in a hospital may need to transmit patient data 112 to a number of handheld devices 110 used by hospital staff. In yet another example, a manufacturing server application 110 may need to send product blueprint data 112 to robots/workstations 120. These application examples are provided for illustrative purposes only and embodiments of the invention are not so limited.

In these applications, one solution for secure communication between server application 110 and client devices 120 may involve the application 110 encrypting data and then sending it to client devices 120. However, this configuration may require the programmers of the application 110 to expend much time and resources to develop and manage the encryption infrastructure. In contrast, in one embodiment of the invention, the application 110 interfaces with an encryption management system 130 and allows the encryption management system 130 to manage the encryption and sending of data 112. To utilize the encryption management system 130, the application 110 passes data (and references) 112 to a template 114 and applies that template to the data. The template 114 is then sent to a template engine 134 within the encryption management system 130 for processing. During the processing of the template 114, the template engine 134 may retrieve objects and keys from the secure object database 132 as needed. The objects and keys are needed to process the template 114 as well as format and/or encrypt the resultant message 136. The resultant message 136 is then sent to a secured channel engine 138 for further security enhancement. The security enhancement readies the message 136 to be sent via an active security protocol through a network 140 to the one or more client devices 120. The final encrypted message 148 containing data 112 is then sent to the client devices 120. The operation of a template is further described in conjunction with FIG. 1B.

### 2. TEMPLATE FEATURES

In various embodiments, the encryption management system 130 provides a security boundary inside which security functionality can be scripted in a template. In one embodiment, a template is a configurable file or input mechanism through which variables, functions, and other data structures can be defined or referenced in accordance with an application programming interface (API). A server-based application 110 that needs to utilize the encryption management system can invoke the security functions defined in an API via a template. The template architecture provides to any calling application, in the form of a consistent API, access to cryptographic functions internal to the encryption management system, as well as custom functionality implemented via extensible modules.

2.1. Data Processing

In one embodiment, the encryption management system can receive data dynamically from the calling application via templates. This functionality is achieved by not fixing the number of parameters at the interface, but rather by determining the number of parameters through the template definition. In one embodiment, the calling of the template function supports a variable argument list.

The template also allows message data to be combined and transformed in a flexible manner. For example, through the use of placeholders, external data passed as parameters to the encryption management system can be combined with pre-defined data in the template (defined as literals) as well as variable data returned from internal functions to produce the output message. In some embodiments, templates provide the ability to chain together internal functions with supporting transformation functions (such as concatenation or binary encoding). The template architecture supports the ability to pass the output of one internal function to the parameter/input of another internal function.

Besides variables, templates also support the use of static data. Often, data needed in the execution of the template functionality will be fixed for every pass through of the template. As such, in one embodiment, the template architecture supports the ability to pass integer literals, string literals, and/or binary string literals as parameters to internal functions. Data concatenation allows pre-defined static data to be combined with variable data. The output from a concatenation can be used as the input to an internal function.

In one embodiment, the output of a template is a binary string that is transformed by a secure channel algorithm into a secure message. The secured message is then sent directly to the target client device specified by the calling server application. Alternatively, a secure channel algorithm can be applied to the template and the message may be returned to the interfacing (calling) application for out of band message transport. As a result, the template architecture allows sensitive internal data such as key material to be placed into a secure channel message without exposure to the external application. In other embodiments, templates can access internal data and keying material within the encryption management system that have been allowed to be exported based on policy attributes associated with the sensitive data.

2.2. Security Boundary

In one embodiment, a security policy prevents sensitive data from being released beyond the security boundary unencrypted. Template functionality is executed within the security boundary of the template-based encryption management system. Binary-conversion of templates (template compilation) also ensures that no template functionality is executed outside of the security boundary and no sensitive data is revealed in the process. The use of a security boundary also makes its possible to retrieve a sensitive cryptographic key in a template and then send that key over a secure channel where no encryption is applied (null secure channel). The execution of the template prevents sensitive data from being processed and sent in the clear if a secure result is not ensured.

### 3. TEMPLATE CONFIGURATION

In one embodiment, a template is a human readable text file with a pre-defined format that enables the external application 110 to pass instructions and data to the template engine 134. A template can be constructed to perform data transformations, encryption management system modifications, or encryption management system queries. Construction of a template may involve defining the following optional components in a text file: (1) template parameters, (2) template operations, and (3) output binary structure. FIG. 1B shows the relationship among these three components in the context of template execution.

As shown in FIG. 1B, template parameters 152 serve as inputs to the template operations 154 that will be performed by the template engine 134. The process of defining these parameters includes specifying each parameter's data type and labeling the parameter with a unique string identifier. Template parameters allow the external application (110) to supply inputs into the template engine 134 during the invocation of the template 114.

The second optional component involved in the construction of a template is a set of template operations 154. Template operations are specified operations that the encryption management system 130 performs during execution of the template. The set of valid template operations is defined by the encryption management system template language specification (i.e., the API). Certain template operations are pre-defined and the external application 110 can specify in template operations 154 which of the pre-defined operations are to be executed. As shown in FIG. 1B, template operations 154 may utilize data and/or objects 164 from the secure object database 132 in combination with template parameters 152 from application 110 and data that is built-in to the template environment (e.g., the current time). For example, the operations may involve performing cryptographic operations on a set of data (e.g., input data 112 embedded within template 114) using keys 166 stored in the secure object database 132. In one embodiment, the defined set of template operations is extensible using specially defined plug-ins that are tailored to the application 110's usage of the encryption management system.

The third optional component involved in the construction of a template is the output structure 156, which governs the binary structure of the output that is produced as a result of executing the template. Template output may be sent to another entity connected to the encryption management system or it may be returned to the calling application 110. In one embodiment, the structure of the output data is defined by the template and can be fed by template inputs as well as from the results of template operations. In another embodiment, before the output leaves the encryption management system 130, it passes through the secure channel engine 138 to obtain additional security enhancements before transmission.

In one embodiment, once a template is constructed, it is imported into the encryption management system and registered inside the template engine 134 with a specific template ID number. Templates can be imported, replaced, or deleted within the encryption management system 130 at any time without requiring a restart or code change within the encryption management system environment.

In one embodiment, a template follows the following life cycle. First, a template is created using a template construction tool that aids in assembling the template functionality, for instance through an easy to use GUI. Once the template is created, the template construction tool performs static analysis of the template to validate and ensure that the template has no obvious errors. Then, the validated template is loaded onto the encryption management system by an administrator. In one embodiment, loading a template into the encryption management system begins the template binary conversion process, which results in the template being stored into the secure object database. Once the template is in the secure object database, the template can be executed with one of the encryption management application API calls that utilize templates to create a message for delivery to the client device. Once in use, the template may undergo further testing and refinement, and may be deleted from the encryption management system by an administrator when it is no longer needed.

### 4. TEMPLATE EXECUTION

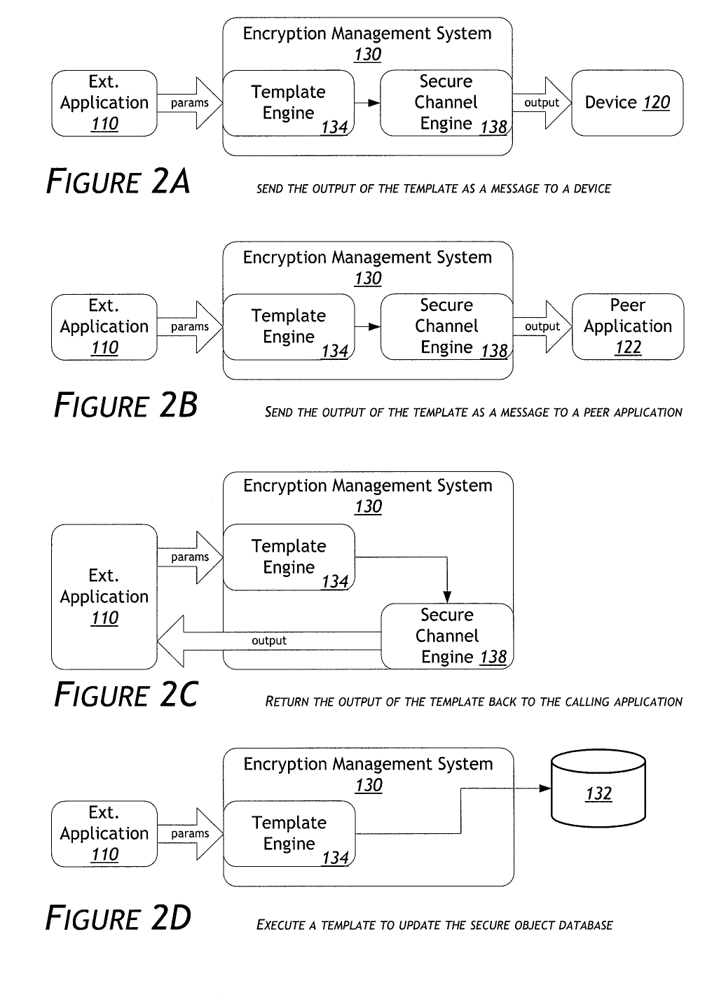

Once a template has been registered in the encryption management system, the external application 110 can utilize an application library to invoke a template using a template API call. In one embodiment, during template invocation, the external application 110 supplies the registered template ID and any parameters (e.g., template parameters 152) defined for that template. Behavior of the template invocation is further governed by the specific template API call used to invoke the template. In one embodiment, the template engine 134 supports at least the following API calls:
Send the output of the template as a message to a device—As shown in FIG. 2A, in this template operation the external application 110 passes parameters to the template engine 134, which in turn generates a message that is processed by the secure channel engine 138 and sent to a device 120.
Send the output of the template as a message to a peer application—As shown in FIG. 2B, in this template operation the external application 110 passes parameters to the template engine 134, which in turn generates a message that is processed by the secure channel engine 138 and sent to a peer application 112.
Return the output of the template back to the external (calling) application—As shown in FIG. 2C, in this template operation the external application 110 passes parameters to the template engine 134, which in turn generates a message that is processed by the secure channel engine 138 and sent back to the external (calling) application 110.
Execute a template to update the secure object database 132—As shown in FIG. 2D, in this template operation the external application 110 passes parameters to the template engine 134, which in turn operates to update the secure object database 132.

In one embodiment, output data resulting from a template operation is sent to the secure channel engine 138 to secure the content within the output data using the currently active secure channel protocol. In one embodiment, data is not sent out or returned to the calling application without being processed with a secure channel encryption mechanism. This ensures that any critical security parameters contained with the output of the template (perhaps fetched from the secure object database 132 using a template operation) will not be extractable from the encryption management system in the clear.

In one embodiment, existing objects 166 within the secure object database 132 can be referenced within a template by utilizing numeric identifiers called UseIDs. UseIDs uniquely identify specific types of objects at the application level as well as at the device level. For example, a template could have a UseID with a numeric value of “1” that represents an asymmetric signing key, with the “1” referencing the actual key stored within the secure object database 132. Depending on how this UseID is utilized in the encryption management system 130, it could be used within a template to reference a single application-wide signing key, or a device specific signing key that exists for every client device 120 in the secure object database 132.

4.1. Template Operation Example: Generate and Send Key

As previously illustrated in FIG. 1A, one template functionality of the template-based encryption management system applies a secure-channel algorithm (through secure channel 138) to sensitive data that has undergone no other encipherment process but the security channel itself. One example case where this can be used is the case in which it is necessary to generate application-specific cryptographic keys and send them securely to a client device.

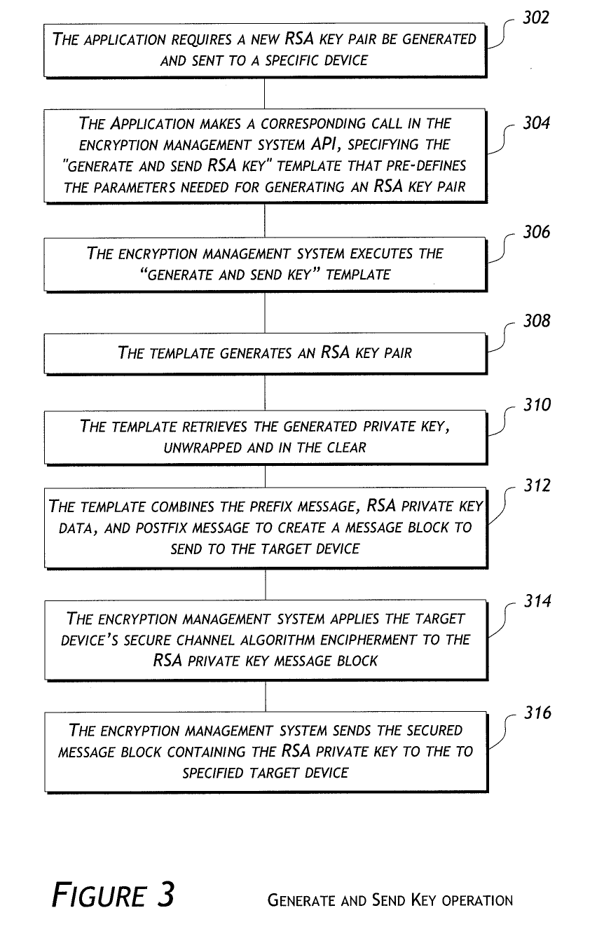

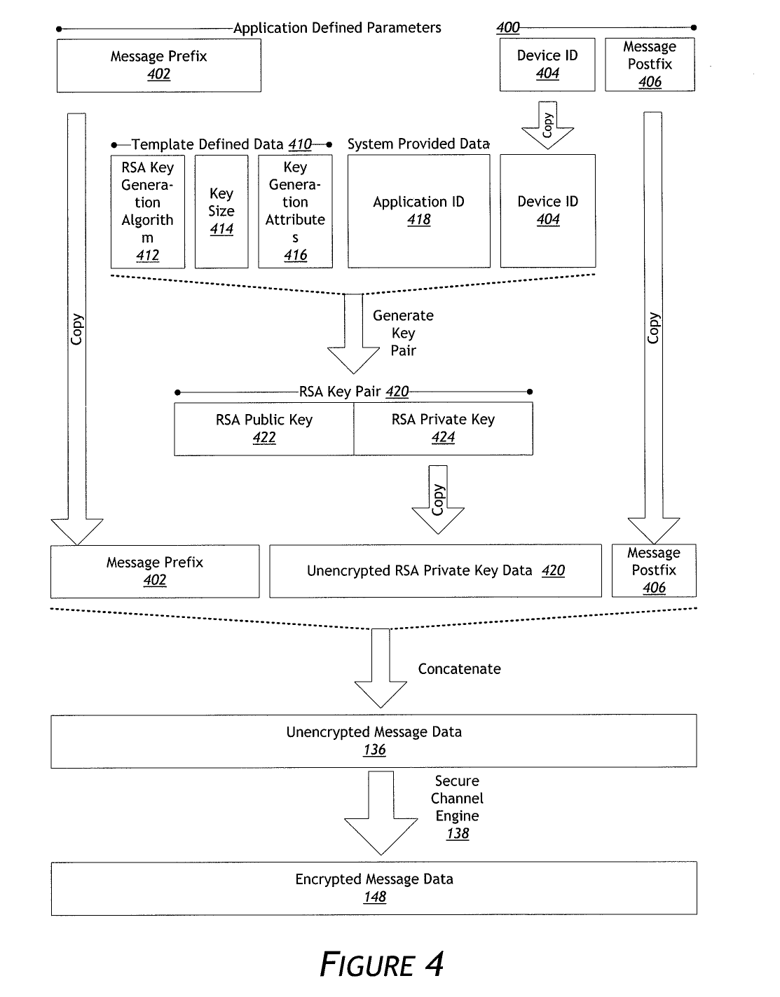

FIG. 3 illustrates the steps taken in a “generate and send key” operation while FIG. 4 illustrates the data message format of the operation. In step 302, the server application (e.g., application 110) requires a new RSA key pair be generated and sent to a specific client device. The RSA private key may be embedded in a specifically formatted message in order for the client device application to properly interpret it. In step 304, the server application makes an appropriate call in the encryption management system API. In one embodiment, the server application makes a SendBlockToDeviceViaTemplate( ) call, specifying the “generate and send RSA key” template that pre-defines the parameters 400 (FIG. 4) that are needed for generating an RSA key pair.

In one embodiment, the server application provides three parameters 400 to the function call: (a) the device ID 404 of the client device to which the resultant message should be sent; (b) the prefix of the message 402 to be sent to the client device; and (c) the postfix of the message 406 to be sent to the client device. The prefix 402 will be prepended to the key, while the postfix 406 will be appended to the key. Next at step 306, the template-based encryption management system executes the “generate and send key” template. The template takes as input template defined data 410, system-provided data, and the device ID 404. In one embodiment, template defined data 410 additionally includes RSA generation algorithm 412, key size 414, and key generation attributes 416. The system-provided data may additionally include an application ID 418. This application ID 418 is used to indicate the ID of the application that is sending the message to the encryption management system, as one embodiment of the encryption management system supports handling messages from multiple applications on the server side being sent to remote client devices. Since it may be useful for a remote device to know the source of the message specifically down to the application that sent it, this application ID transmits the identity of the sending application to the remote device.

Then at step 308, the template generates a RSA key pair, which includes a RSA public key 422 and a RSA private key 424 in one embodiment. This is followed by step 310, where the template retrieves the generated RSA private key 424, unwrapped and in the clear. At step 312, the template combines the prefix message 402, the RSA private key data 420, and the postfix message 406 to create a message block 136 to send to the target client device. Then at step 314, the template-based encryption management system applies the target client device's secure channel algorithm encipherment to the RSA private key message block 136 to create an encrypted message data block 148. Finally, at step 316, the template-based encryption management system sends the secured message block 148 containing the RSA private key 424 to the specified target client device.

This operation shows one advantage of executing the template within the security boundary. The cryptographic key is retrieved in the clear to apply the secure channel algorithm to it for secure transport to the client device. By executing the template within the encryption server's security boundary, the cleartext sensitive data is protected until it is placed in an enciphered message format.

4.2. Template Operation Example: Wrap and Send Key

A common practice for handling cryptographic keys is to wrap (encipher) them before export. Because a wrapped key is not particularly sensitive, an application key or a client device key stored within the template-based encryption management system could be exported to the interfacing application (e.g., application 110 in FIG. 1) in a wrapped form. There are at least two reasons for executing the wrapping functionality from within a template: convenience and extensibility.

First, using an interface where several cryptographic calls must be made to wrap a key can often be very inconvenient to an interfacing application. The cryptographic sub-system must be initialized, the wrapping key must be retrieved, the target key to be wrapped must be retrieved, and the wrapping algorithm must be executed. Also, there are often complicated intermediate steps and parameters required. Embodiments of the invention eliminate these inconveniences by providing key wrapping functionalities to the interfacing application's developer with a template and single API call. The API call can be executed using a small number of parameters, allowing for the same key wrapping functionality to be accessed in a convenient interface with much less work and in a less complicated fashion.

Second, a custom cryptographic wrapping function may be desirable. As previously described, extending the template-based interfacing application API to support custom algorithms and functionality is one of the advantages of templates. A template can provide access to a custom wrapping function with a flexible parameter list appropriate to that function.

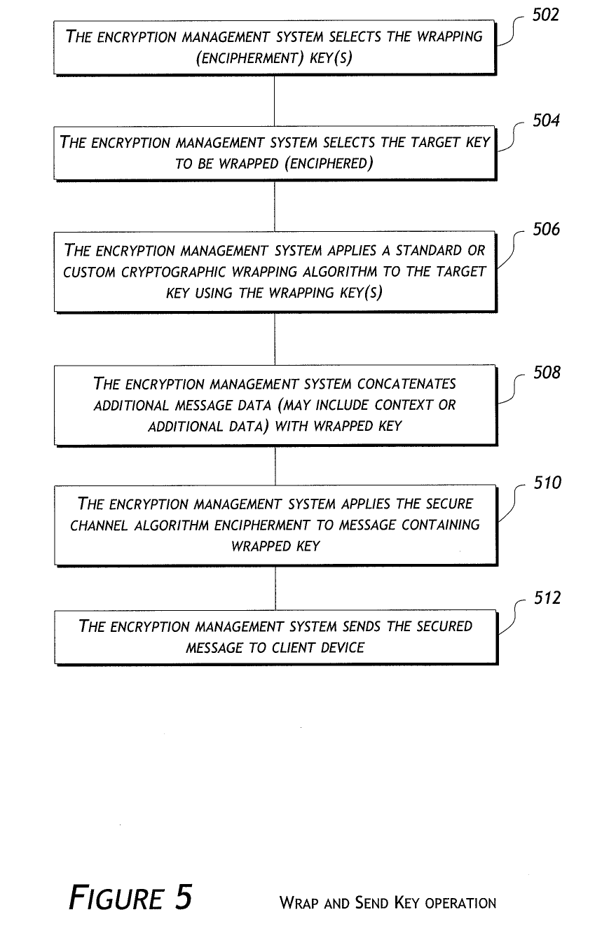

FIG. 5 shows the steps of the “wrap and send key” operation. At step 502, the encryption management system selects the wrapping (encipherment) key(s). Then at step 504, the encryption management system selects the target key to be wrapped (enciphered). Next, at step 506, the encryption management system applies a standard or custom cryptographic wrapping algorithm to the target key using the wrapping key(s). At step 508, the encryption management system concatenates additional message data (which may include context or additional data) with wrapped key to generate a resultant message 136. Then at step 510, the encryption management system applies a secure channel algorithm encipherment to the message 136 containing wrapped key. Finally, at step 512, the encryption management system sends the secured message 148 to the specified client device.

This template-based operation makes an otherwise fairly complex sequence conveniently accessible to an interfacing application. The interfacing application needs to provide only a small number of variable parameters required for the key retrieval and wrapping functions. Finally, though not specifically called out, a template can provide for the specification of fixed parameters to the internal functions through string or binary literals. This reduces the number of parameters that the interfacing application needs to provide to the template thus also adds to the convenience of using a template rather than a direct interface to the internal functions of an encryption sub-system.

4.3. Template Operation Example: Custom Function

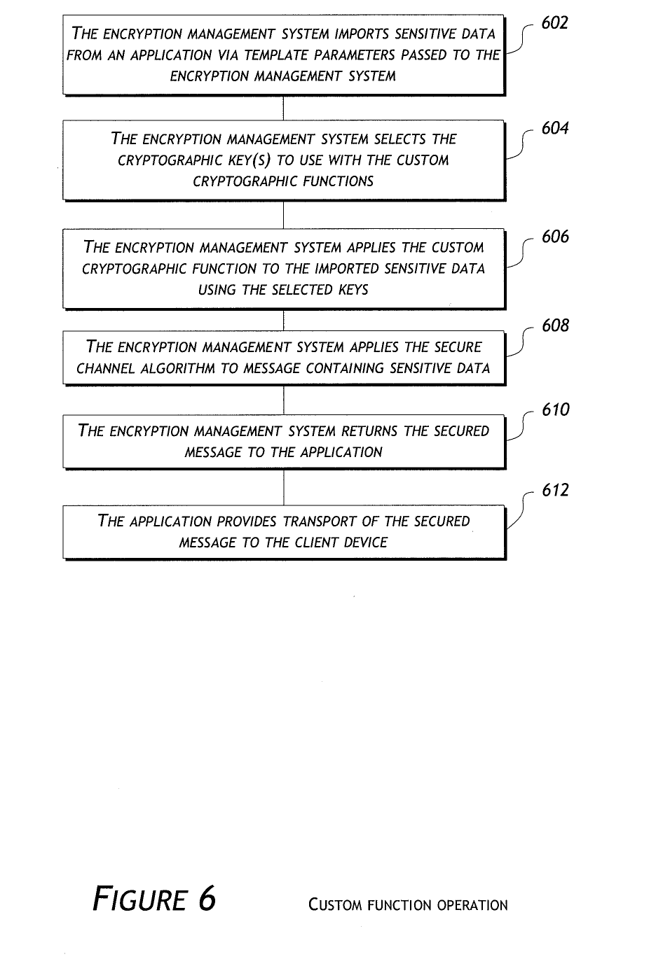

In one embodiment, templates allow access to custom functionality without modifying the interfacing API. For example, a custom wrapping function may be used in the “wrap and send operation” described previously. FIG. 6 shows the steps of an example custom function operation. In this operation, a custom cryptographic function is used to protect external data with keys stored internally to the template-based encryption management system. This operation also includes using external delivery of the secured message with the template functionality. At the start of the operation, at step 602, the encryption management system 130 imports sensitive data. This data (keying material or some other sensitive data) is passed via parameters to the template and may be protected by pre-shared or pre-trusted encipherment keys between the encryption management system and the interfacing application. Then at step 604, the encryption management system selects the cryptographic key(s) to use with the custom cryptographic functions. Next at step 606, the encryption management system applies the custom cryptographic function to the imported sensitive data using the selected keys. Following this step, the encryption management system then applies the secure channel algorithm 138 to a message 136 containing sensitive data at step 608. At step 610, the encryption management system returns the secured message 148 to the interfacing application. Finally, at step 612, the interfacing application provides transport of secured message to the client device.

Although there may be instances where some data or keying material can be sourced external to the template-based encryption management system, in various embodiments the encryption management system provides what is needed to communicate data to a client device (e.g., the application specific keys and the secure channel keys). Advantageously, templates are able to import external data and apply cryptographic transforms with keys managed by the template-based encryption management system.

### 5. APPLICATIONS OF THE ENCRYPTION MANAGEMENT SYSTEM

Having described example operations of the encryption management system, the following sections provide example real-life applications of the encryption management system.

5.1. Manufacturing Line Application

The encryption management system can be used in a manufacturing line environment. A common problem encountered in the design and implementation of manufacturing line is the protection of sensitive product design data. For example, a workstation on an electronics manufacturing line is responsible for the programming of a firmware image into a chip (Flash, ASIC, CPLD, etc.). The binary image that is to be programmed into the chip may contain unique product design data (e.g., cryptographic keysets, configuration data, software image, etc.) that should not be exposed during the programming process. Assuming that a single unique hardware key already exists within the device being programmed (e.g., the chip), only the device and the manufacturer should have access to this data.

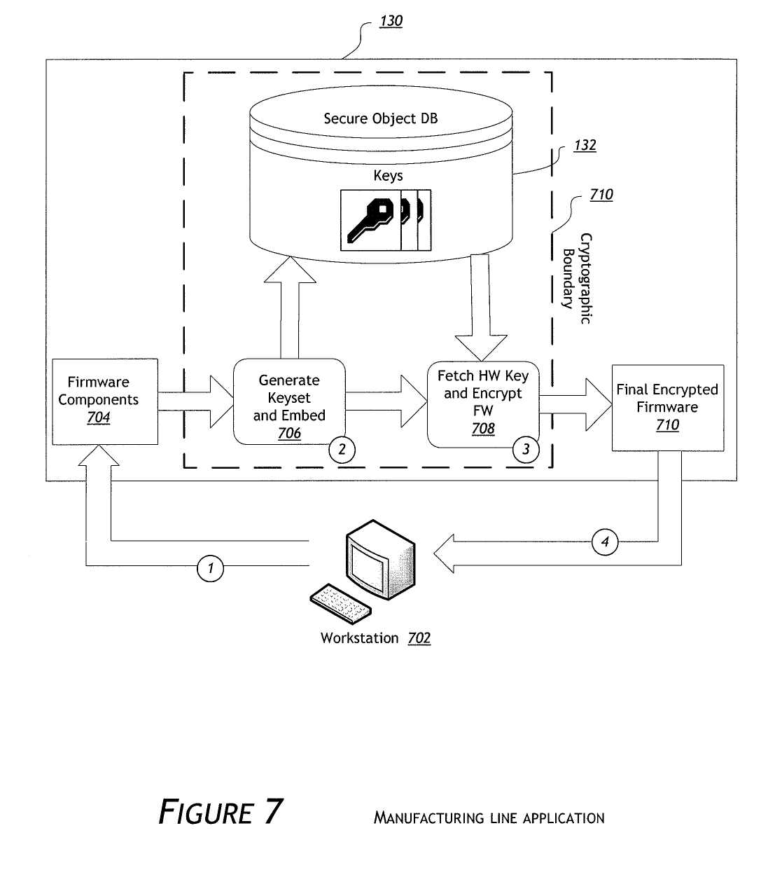

In one embodiment the encryption management system can be used to protect this sensitive data. FIG. 7 illustrates the application. At step 1, a template is constructed that takes the non-sensitive components 704 of the firmware image as inputs from the workstation 702 that is invoking the template. At step 2, the template as executed (706) generates a unique image (which may contain cryptographic keysets, configuration data, software image, etc.) for each device/invocation of the template, and embeds this keyset into the firmware image for the device. Then at step 3, the template as executed (708) encrypts the entire image with the device unique hardware embedded key fetched from secure object database 132. At step 4, the finished output 710 is returned to the workstation 702 for programming of the device without exposing any of the unique image outside the cryptographic boundary 710 of the encryption management system 130.

5.2. Media Content Management Application

The encryption management system can also be applied in the media content management context. In this context, a typical setup involves a discrete piece of media content (audio, text, video, application, etc.) that has been encrypted with a keyset (e.g., a “Keyset A”) in order to protect the media from unauthorized access during distribution. When the asset is entitled to a customer (e.g., a cable TV subscriber), Keyset A is transmitted to the customer's location to allow them access to the media. Typically, the same Keyset A is used to protect this asset with every customer who is entitled to the media. However, this raises the challenge of preventing the possibility of a security breach of this media asset while still distributing Keyset A to only the authorized customers in a secure manner.

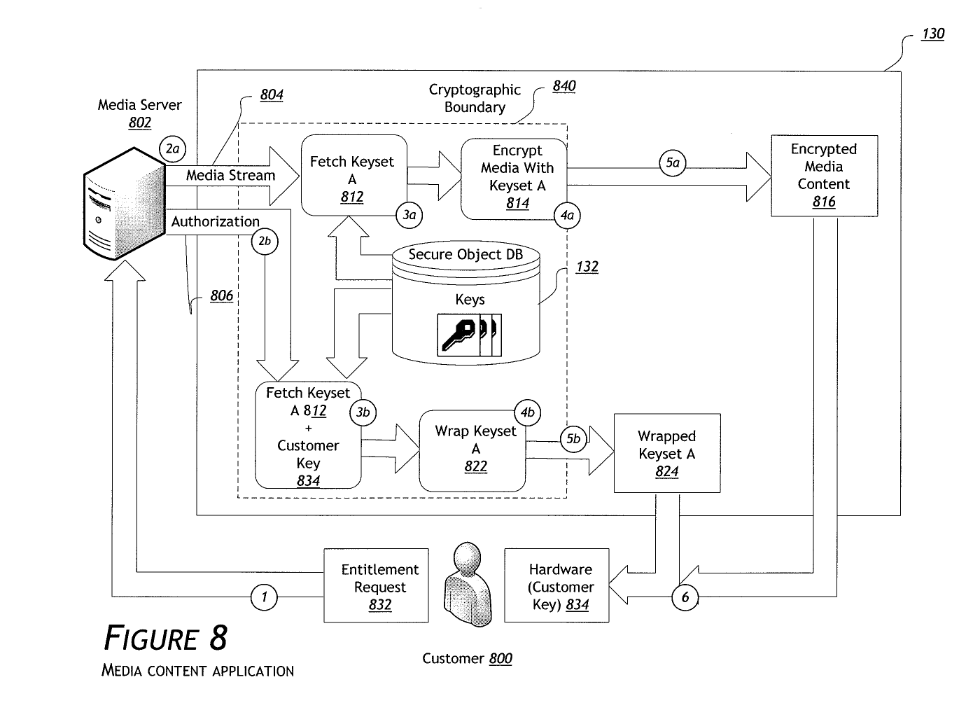

In one embodiment, the encryption management system is used to provide a solution to add security both at the point of distribution and at the point of termination of a media distribution context. The application is shown in FIG. 8. On the termination side (customer side), a piece of hardware 834 (e.g., a set top box) with an embedded unique customer key is used to protect Keyset A from ever being exposed outside of hardware. The hardware 834 can be considered as a client device 120 as previously shown in the general application FIG. 1A.

On the distribution side, a media server 802 (e.g., a media server hosted by a cable TV provider) is tasked with distributing media content to the customer 800. At the start of the process, the customer 800 sends an entitlement request 832 to the media server 802. The request may contain, for example, a request to download a movie. Then at step 2a, the media server 802 sends a media stream 804 to the encryption management system 130. Then at step 3a, the template execution results in a fetching operation 812 that fetches Keyset A from the secure object database 132. The media stream is then encrypted with Keyset A at the process 814 (step 4a). Then at step 5a, the encrypted media content 816 is sent to the customer hardware 834.

In parallel or substantially parallel time, in step 2b, the media server sends an authorization 806 to the encryption management system 130. The authorization 806 may result from the media server checking the customer's accounting or billing information to ensure that the customer 800 is entitled to download the media content. The encryption management system 130 receives the authorization 806 via a template that is constructed to retrieve the unique customer key 834 and Keyset A 812 from the secure object database 132 at step 3b. At step 4b, the template then performs a key wrap operation 822, wrapping Keyset A 812 with the customer unique key 834. This wrapped Keyset A 824 is then distributed to the customer at step 5b. The wrapped keyset is delivered at the time of media content entitlement. All of these steps are performed without ever exposing Keyset A outside the encryption management system's cryptographic boundary 840. At step 6, to decrypt the encrypted media content, the customer loads the wrapped key into their hardware, where Keyset A is unwrapped with their unique customer key and used to decrypt the media content.

The benefit of using the encryption management system in this context is that the template engine allows for custom formatting and cryptographic processing of the key material to produce an entitlement in the proper format for the target customer device. This is executed in a secure environment to eliminate the potential of exposing sensitive system keys needed to protect the media content. Those skilled in the art will recognize that the operation depicted in FIG. 8 is not limited to the secure delivery of media content. For example, the operation can be used to securely transmit software, voice data, corporate data, financial data, and other sensitive data.

### 6. TEMPLATE DESIGN

In one embodiment, the template is specified through an XML structure. The structure can be validated by an XML Schema. The template as an XML document is easy to create by hand or using a template creation tool. It is easy to read by humans and easy to parse by computers. It is also possible to speed up operation by converting the template into a binary form so that text parsing at the time of template execution is not required.

6.1. Template Element

The template element is the root of the XML structure of the template. Example attributes for the template element include:
/Template/@name—This attribute specifies the name of the template that can be used to reference the template through the template-based encryption server application API.
/Template/@version—This attribute specifies the version of the template structure.

For example:

<Template name=“wrap and send key” version =“1.0”>
</Template>

6.2. Specifying External Parameters

External parameters passed to the template are specified in name and in type to be used as variables within the template. This is similar to the format parameter in a printf( ) function call which specifies the type of each parameter in the following parameter list. The template API call can take a variable length parameter list and the parameter types in the list are specified in the template.

There is a set of standard system-provided data that is available to the template including device ID (provided by the interfacing application), application ID and other application context data. In one embodiment, this data is not be explicitly defined as external parameters to the template. This data is also implicitly provided to internal functions as well.

Example attributes for the template element include:
/Parameters—This element contains an ordered list of parameter elements. The order of the parameter elements will be used to interpret the variable length parameter list passed to the template.
/Parameters/Parameter—This element specifies an external parameter passed to the template in via one of the template API calls in the variable length parameter list. The attributes of this element specify the name and type of the parameter.
/Parameters/Parameter/@name—This attribute specifies the name of the parameter. It is a string value. This name is used to reference the parameter when passed to other template functions. Parameter names must always begin with a hash (‘#’) character to distinguish them from string literals.
/Parameters/Parameter/@type—This attribute specifies the type of the parameter passed to the template. It is a string value. The type can be one of: “integer,” “string,” “binary.”

For example:

```
<Parameters>
    <Parameter name=“#label” type=“string” />
    <Parameter name=“#wrapkey_useID” type=“integer” />
    <Parameter name=“#var_message_prefix” type=“binary” />
</Parameters>
```

6.3. Use of Internal Variables

Internal variables are used to pass the data from the output of template functions as a parameter to another template function. Internal variables do not need to be specified before use. However, it may also be desirable to define some internal variables in advance in order to determine its type or context.

The naming of an internal variable is the same as that of an external parameter. Internal variable names are strings that begin with a hash (‘#’) character. The type of the internal variable is the same as the type of the output parameter where that internal variable name is first used.

Internal variables are only assigned value by being specified as the output attribute of a function. Thus, an internal variable name is first specified as the output parameter from an internal function before it can be used as an input parameter to another function. If the internal variable's value is not set using an output parameter first, then subsequent use of the parameter will be considered an error since the value of the variable will not be set.

In one example, there are three internal variables: “#wrapping_key”, “#key_to_wrap”, and “wrapped_key”. They are all of type integer, which is the type of the output parameter, and they are all specified first as the output parameter of a template function. So, for example:

```
<FindKey outputKeyID=“#wrapping_key” useID=“WRAP_Key1” />
<FindKey outputKeyID=“#key_to_wrap” useID=“#p1_tgt_useID” />
<WrapKey outputKeyData=“#wrapped_key”
    targetKeyID=“#key_to_wrap”
    wrappingKeyID=“#wrapping_key”
    wrappingAlgoID=“RSA” />
```

6.4. Template Output

There is a reserved name for an internal template variable that is used to specify the output of the template transform procedure.

The “output” variable is specified as: #OUTPUT. When this internal variable is specified as the output parameter of a transforming function the data is then provided to the secure channel algorithm which is specified as part of the template API call.

6.5. Use of Literals

Literals can be used for most any content and function parameter values in the template that can be fixed by the template designer. Literals can be used in most places that external parameters and internal variables can be used. Literals cannot be used as the value of output parameters if they are to be used elsewhere in the template.

6.5.1. String Literals

String literals are specified using any ASCII printable character. A string literal can be specified for any attribute or element content that takes a string type.

### Example #1

```
<Concatenate output=“#OUTPUT”>
  <string>Concatenate this string </string>
  <string>with the one that follows it</string>
</Concatenate>
```

The content of the string elements are string literals.

### Example #2

decryptionAlgoID=“AES”

The value of the decryptionAlgolD attribute is a string literal.

6.5.2. Integer Literals

An integer literal is similar to a string literal except that it contains only numerical characters from 0-9. An integer literal can be specified for any attribute or element content that takes an integer type. Any non-numeric characters in an integer literal will cause an error if the type prevents it. An integer literal will be interpreted as a string if the type calls for a string.

### Example

useID=“5402341”

6.5.3. Binary Literals

Because XML specification state that binary data must be encoded, a binary literal is specified as base64 encoded data as specified in RFC4648.

### Example

<bitstring>W3NvbWUgbWVzc2FnZSBoZWFkZXJdDQo=</bitstring>

The bitstring element in the concatenate function requires binary data. When binary data is specified by value the content is base64 encoded data. The following Base64 data decodes as “[some message header]”.

6.6. Transform Procedure

A template uses a transform element. This element specifies an ordered list of functions that manipulate the incoming data passed through external parameters, literal data, and data output from the template functions to result in a single binary string value that is the result of the template.

The transform element specifies at least one internal function. For example, one internal function specifies the output variable which is the result of the transform.

The transform element does not have any attributes.

### Example

```
<Transform>
  <FindKey outputKeyID=“#wrapping_key” useID=“WRAP_Key1” />
  <FindKey outputKeyID=“#key_to_wrap” useID=“#p1_tgt_useID” />
  <WrapKey outputKeyData=“#wrapped_key”
  targetKeyID=“#key_to_wrap”
    wrappingKeyID=“#wrapping_key” wrappingAlgoID=“AES” />
  <Concatenate output=“#OUTPUT”>
    <bitstring>aGVhZGVy<bitstring>
      <bitstring content=“#p4_message” />
      <bitstring content=“#wrapped_key” />
  </Concatenate>
</Transform>
```

This transform example wraps a key and then embeds the wrapped key with some literal data and external data. The concatenate function contains the output variable as required for the transform element.

6.7. Function Definitions

Functions within the template are specified by xml elements. Parameters to the function are specified as attributes or sub-elements. Most simple parameters of type string, integer, or binary string can be specified as attributes. More complex parameters whether complex types, objects, or arrays can be specified via sub-elements if they cannot be specified as an attribute in one of the basic types.

There is a set of standard system-provided data passed to the function, including device ID (provided by the interfacing application), application ID, and other application context data. This data does not need to be explicitly passed to the function nor does it need to be defined as an external parameter to the template.

In most cases, functions also define an output attribute to which an internal variable can be assigned. This is because most functions “transform” data or retrieve data. Alternatively, for functions which store or modify data, no output data may be needed. However, even in these cases and output variable may be desirable, for instance, to output confirmation data or an echo.

6.7.1. Internal Functions

The template functionality provides a standard set of cryptographic and manipulative functions. These interface to these functions and their parameters are defined in the Template Functions section.

These functions and their parameters can be statically validated by an XML Schema to ensure that they are constructed correctly. Furthermore, static validation will be performed on the variables and literals passed as parameters to ensure type matching and to eliminate static errors before execution.

Some functions also specify one or more algorithms that are used in the execution of the function. As much as possible, the number of these algorithms is extended to support custom algorithms or unimplemented algorithms without modifying the function interface.

6.7.2. Custom Functions

Custom functions can be developed and accessed from within the template transform procedure. They follow the same guidelines as internal functions. External XML Schemas will be provided for these functions so that their specification in a template can also be statically validated before the template is executed.

In one embodiment, a mechanism is also provided within the template-based encryption server to load the modules containing the custom functionality so that these custom functions are callable during the execution of the template. This allows external modules to be loaded into the encryption server without having to recompile the template-based encryption application itself.

6.7.3. Comments in Templates

In one embodiment, it is possible to write comments into templates.

6.7.4. Error Handling

Errors in template execution are returned to the calling application via an error code with well defined and meaningful return values. Static errors are errors that can be discovered before execution of the template. These include, for instance, errors in template integrity, errors in type mismatch in external parameters and the function parameters to which they are passed, errors in type mismatch between internal variables and the function parameters to which they are passed, and errors in type mismatch in literals. Dynamic errors are errors that occur during execution of the template. These include, for instance, errors in casting external parameters to defined types and errors in function execution.

7. Template Functions

The template functionality enables a wide variety of features. Examples of these features are given in the text below.

7.1. ImportKey

This function imports sensitive key material or other data to be used by the template or stored internally to template-based encryption server. Because the key wrapping function works on an object ID, data is imported before wrapping.

Parameters:
outputKeyID—An output value of type object ID. A handle to the imported key to be used as input to other functions. This attribute is specified as an internal variable.
keyData—Binary string representing the sensitive material or key to be imported. It can be an external parameter, internal variable, or a binary string literal.
decryptionKeyID—If this is null it is assumed that the imported data is passed in the clear.
decryptionAlgoID—One of two string values, this parameter may be set to “AES,” “RSA,” or “NULL.” If this is null it is assumed that the algorithm can be deduced from the type of the key specified in the decryptionKeyID parameter.
decryptionAlgoAttributes—This is an element that specifies attributes to use in the key generation algorithm. The format of the data is an attribute template specific to the decryption algorithm specified.
storage—One of two string values. “temp” means the imported key or data is deleted at the end of the template execution. “perm” means the imported key or data is stored in the encryption server for future use.
useID—Specifies the useID to store the key pair to. In this embodiment, this is an existing useID created through the admin interface. If storage parameter is “perm” this param allows data or key to be found for future reference. Otherwise, it is ignored.

### Example #1

```
<ImportKey outputKeyID=“#imported_data”
  keyData=“#param1”
  decryptionKeyID=“#App_AES_Enc_Key”
  decryptionAlgoID=“AES”
  storage=“perm”
  useID=“GlobalAESKey” />
```

### Example #2

```
<ImportKey outputKeyID=“#imported_key”
  keyData=“#param1”
  decryptionKeyID=“#App_RSA_Pub_Key”
  decryptionAlgoID=“RSA”
  storage=“temp” />
```

### Example #3″

```
<ImportKey outputKeyID=“#imported_key”
  keyData=“#param1”
  decryptionKeyID=“#App_AES_Enc_Key”
  decryptionAlgoID=“AES”
  storage=“temp” >
  <decryptionAlgoAttributes>
    <aesAttributes>...</aesAttributes>
  </decryptionAlgoAttributes>
</ImportKey>
```

7.2. GenerateKey

Generate key will generate a secret key data structure according to the key type specified and return a object ID handle to it to allow it to be used in other template functions.

If the storage parameter specifies permanent storage, then the key will be stored in the encryption server database along with the optional parameters for future retrieval.

Parameters:
outputKeyID—An output value of type Object ID. A handle to the generated key to be used as input to other functions. This attribute is specified as an internal variable.
genKeyAlgo—Specifies the key algorithm to determine what type of key to generate. This attribute is of type string.
genKeyAttributes—This is an element that specifies attributes to use in the key generation algorithm. The format of the data is an attribute template specific to the key generation algorithm specified.
storage—One of two string values. “temp” means the imported key or data is deleted at the end of the template execution. “perm” means the imported key or data is stored in the encryption server for future use.
useID—Specifies the useID to store the keypair to. In this embodiment, this is an existing useID created through the admin interface. If storage parameter is “perm” this param allows data or key to be found for future reference. Otherwise, it is ignored.

### Example #1

```
<GenerateKey outputKeyID=“#generatedKeyID”
  genKeyAlgo=“AES”
  storage=“perm”
  useID=“EncryptionKey2” />
```

### Example #2

```
<GenerateKey outputKeyID=“#generatedKeyID”
  genKeyAlgo=“AES”
  storage=“temp”>
  <genKeyAttributes>
    <aesAttributes>...</aesAttributes>
  </genKeyAttributes>
</GenerateKey>
```

7.3. GenerateKeyPair

GenerateKeyPair will generate a public and private key data structure according to the key type specified and return one object ID handle each to the public and private keys to it to allow them to be used in other template functions.

If the storage parameter specifies permanent storage, then the key pair will be stored in the encryption server database along with the optional parameters for future retrieval.

Parameters:
outputPrivateKeyID—An output value of type Object ID. A handle to the generated private key to be used as input to other functions. This attribute is specified as an internal variable.
outputPublicKeyID—An output value of type Object ID. A handle to the generated public key to be used as input to other functions. This attribute is specified as an internal variable.
genKeyAlgo—Specifies the key algorithm to determine what type of key to generate. This attribute is of type string.
genKeyAttributes—This is an element that specifies attributes to use in the key generation algorithm. The format of the data is an attribute template specific to the wrapping algorithm specified.
storage—One of two string values. “temp” means the imported key or data is deleted at the end of the template execution. “perm” means the imported key or data is stored in the encryption server for future use.
useID—Specifies the useID to which the keypair is stored. In this embodiment, this is an existing useID created through the admin interface. If storage parameter is “perm” this param allows data or key to be found for future reference. Otherwise, it is ignored.

### Example

```
<GenerateKeyPair outputPrivateKeyID=“#privKeyID”
  outputPublicKeyID=“#pubKeyID”
  genKeyAlgo=“RSA”
  storage=“perm”
  useID=“RSAKey” />
```

7.4. FindKey

This function retrieves a handle to a key stored and managed by the encryption server. The key handle is then used in another function.

Parameters:
outputKeyID—A handle to be used as input to other functions. This is specified as internal template parameter.
useID—Specifies the useID to store the keypair to. In this embodiment, this is an existing useID created through the admin interface. The key selected from the useID will be based on the context of the application ID and device ID context that the template executes within.

### Example

<FindKey outputKeyID=“#wrapping_key” useID=“WRAP_Key1”/>

7.5. WrapKey

This function wraps (enciphers) one key with another key using the specified algorithm. The result is passed to the output parameter.

Parameters:
outputKeyData—The binary data which results from the wrapping function. This is specified as internal template parameter or the template output parameter.
targetKeyID—A handle to the key to be wrapped. This is specified as an internal variable. This can be returned from any of the FindKey, GenerateKey, GenerateKeyPair, and ImportKey functions.
wrappingKeyID—A handle to the key to use when wrapping the target key. This should be specified as an internal variable. This can be returned from any of the FindKey, GenerateKey, GenerateKeyPair, and ImportKey functions. This attribute can be empty (optional) if the wrapping algorithm is specified as “NULL.”
wrappingAlgoID—The wrapping algorithm. In this embodiment, it may be one of “AES,” “RSA,” or “NULL.” The NULL wrapping algorithm exports the key in the clear if the policy settings on the key allow it. If this is empty it is assumed that the algorithm can be deduced from the type of the key specified in the wrappingKeyID parameter.
wrappingAlgoAttributes—This is an element that specifies attributes to use in the wrapping algorithm. The format of the data is an attribute template specific to the wrapping algorithm specified.

### Example #1

```
<WrapKey outputKeyData=“#wrapped_key”
  targetKeyID=“#key_to_wrap”
  wrappingKeyID=“#wrapping_key”
  wrappingAlgoID=“RSA”>
  <wrappingAlgoAttributes>
    <rsaAttributes>...</rsaAttributes>
  </wrappingAlgoAttributes>
</WrapKey>
```

### Example #2

```
<WrapKey outputKeyData=“#wrapped_key”
  targetKeyID=“#key_to_wrap”
  wrappingKeyID=“#wrapping_key”
  wrappingAlgoID=“AES” />
```

7.6. EncryptData

This function is used to perform encryption on the specified plaintext data blob with the specified key. The result of this operation is passed to the outputData parameter.

Parameters:
outputData—The binary data that results form the encryption operation. This is specified as an internal template parameter or the template output parameter.
encryptionKeyID—A handle to the key used to encrypt the specified plaintext data. This parameter should be specified as an internal variable. This can be returned from any of the FindKey, GenerateKey, GenerateKeyPair, and ImportKey functions.
encryptionIV—An initialization vector required by some (but not all) cryptographic encryption algorithms. If the encryption algorithm requires an IV, this value should be specified as a binary data blob internal variable or as a literal hex or base64 encoded string value.
encryptionAlgo—A literal string value containing a value like “AESCBC” or “AESECB” that indicates the algorithm being used to encrypt the plaintext data.
plaintextData—The data that is the input to this operation that will be encrypted. This is specified as an internal template parameter or as a literal hex or base64 encoded string value.

### Example #1

```
<EncryptData outputData=”#CIPHERTEXT”
  encryptionKeyID=”#ENC_KEY”
  plaintextData=”#PLAINTEXT”
  encryptionIV=”#ENC_IV”
  encryptionAlgo=”AESCBC” />
```

### Example #2

```
<EncryptData outputData=”#OUTPUT”
  encryptionKeyID=”#ENC_KEY”
  plaintextData=”0xA1B2C3D4E5F6”
  encryptionAlgo=”AESECB” />
```

7.7. ConcatenateData

The concatenate function is used to combine data from multiple sources: external parameters, internal function results, and string literals. The output of the concatenate function can either be an internal variable for use in another template function or the template output variable specifying the result of the template transform procedure.

Parameters:
/Concatenate/@result—The result attribute is specified as an internal variable. Alternatively, it is the template output parameter.
/Concatenate/bitstring—There may be one or more <bitstring> elements specified within the <Concatenate> element. The value of a <bitstring> can be specified in two ways, either through the value of the element or through a content attribute.
   Content via value—The content can be specified in the value of the element. The binary data in the element is encoded as a base64 text.
   Content via content attribute—The <bitstring> content can be specified by an external or internal variable set through the content attribute on the <bitstring> element. If the content attribute is specified then any text in the element is ignored and discarded. The variable is of type binary string.
/Concatenate/string—Specifies a string value. There may be one or more <string> element specified. The value of a <string> element can be specified in two ways, just as the bitstring element, through the value of the element itself as a string literal or through a variable passed via the content attribute of the string element.
   Content via value—The content can be specified in the value of the element. The binary data in the element comprises ASCII printable string characters.
   Content via content attribute—The <string> content can be specified by an external or internal variable set through the content attribute on the <string> element. If the content attribute is specified then any text in the element is ignored and discarded. The variable is of type string.

### Example

```
<Concatenate result=“#OUTPUT”>
  <bitstring>W3NvbWUgbWVzc2FnZSBoZWFkZXJdDQo=</bitstring>
  <string>|</string>
  <bitstring content=“#param4” />
  <string>|</string>
  <bitstring content=“#wrapped_key” />
  <string content=“#final data” />
  </Concatenate>
```

### 8. TEMPLATE API

The extensible nature of the template-based encryption server provides access to customer-specific algorithms and functionality without the need to modify the API.

Examples of the functions appropriate to implement the API are given below:

```
ER_RV VA_SC_SendBlockToDeviceViaTemplate(
  unsigned long ulDeviceID, /* Unique identifier of device to
      * receive message */
  unsigned long ulFlags, /* Optional flags for message
      * handling options */
  unsigned long templateID, /* Unique identifier of template
      * to use */
  ... /* variable length parameter list
      * to pass to template */
);
ER_RV VA_EncryptBlockForDeviceViaTemplate(
  unsigned long ulDeviceID, /* Unique identifier of device
        * message is to be encrypted for */
  unsigned long* pulCTDataLen, /* [Output] Ciphertext data length */
  unsigned char* pCTDataBuffer /* [Output] Ciphertext data buffer */
  unsigned long templateID, /* Unique identifier of template
        * to use */
  ... /* variable length parameter list
        * to pass to template */
);
```

Examples of commands that utilize the template-based encryption server's API are given below:

### Example 1

```
<Template name=“wrap and send key”>
  <Parameters>
    <Parameter name=“#p1_tgt_useID” type=“string” />
    <Parameter name=“#p2_message” type=“binary” />
  </Parameters>
  <Transform>
    <FindKey outputKeyID=“#wrapping_key”
    useID=“WRAP_Key1” />
    <FindKey outputKeyID=“#key_to_wrap”
    useID=“#p1_tgt_useID” />
    <WrapKey outputData=“#wrapped_key”
      targetKeyID=“#key_to_wrap”
      wrappingKeyID=“#wrapping_key” />
    <Concatenate result=“#OUTPUT”>
    <bitstring>W3NvbWUgbWVzc2FnZSBoZWFkZXJdDQo=</bitstring>
      <bitstring content=“#p2_message” />
      <bitstring content=“#wrapped_key” />
    </Concatenate>
  </Transform>
</Template>
```

### 9. COMPUTER SYSTEM EMBODIMENT

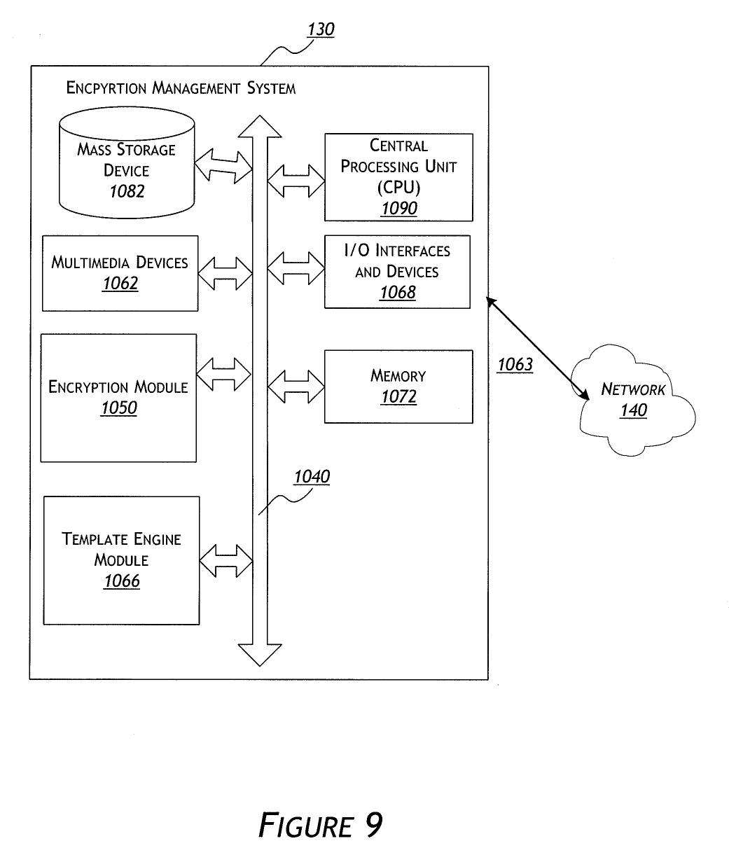

FIG. 9 is a block diagram illustrating the encryption management system 130 in accordance with one embodiment. The encryption management system 130 includes, for example, a personal computer that is IBM, Macintosh, or Linux/Unix compatible. In one embodiment, the encryption management system 130 comprises a server, a desktop computer, a laptop computer, a personal digital assistant, a kiosk, or a mobile device, for example. In one embodiment, the sample encryption management system 130 includes a central processing unit (“CPU”) 1090, which may include one or more conventional microprocessors. The encryption management system 130 further includes a memory 1072, such as random access memory (“RAM”) for temporary storage of information and a read only memory (“ROM”) for permanent storage of information, and a mass storage device 1082, such as a hard drive, diskette, or optical media storage device. The mass storage device 1082 may store the secure object database 132. Typically, the components and modules of the encryption management system 130 are connected to the computer using a standard based bus system 1040. In different embodiments, the standard based bus system 1040 could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of encryption management system 130 may be combined into fewer components and modules or further separated into additional components and modules.

The encryption management system 130 is generally controlled and coordinated by operating system software, such as Windows Server, Linux Server, Windows 98, Windows NT, Windows 2000, Windows XP, Windows Vista, Unix, Linux, SunOS, Solaris, or other compatible server or desktop operating systems. In Macintosh systems, the operating system may be any available operating system, such as MAC OS X. In other embodiments, the encryption management system 130 may be controlled by a proprietary operating system. Conventional operating systems control and schedule computer processes for execution, perform memory management, provide file system, networking, I/O services, and provide a user interface, such as a graphical user interface (“GUI”), among other things.

The sample encryption management system 130 includes one or more commonly available input/output (I/O) devices and interfaces 168, such as a keyboard, mouse, touchpad, and printer. In one embodiment, the I/O devices and interfaces 168 include one or more display device, such as a monitor, that allows the visual presentation of data to a user. More particularly, a display device provides for the presentation of GUIs, application software data, and multimedia presentations, for example. The encryption management system 130 may also include one or more multimedia devices 1062, such as speakers, video cards, graphics accelerators, and microphones, for example. In other embodiments, such as when the encryption management system 130 comprises a network server, for example, the computing system may not include any of the above-noted man-machine I/O devices.

In the embodiment of FIG. 9, the I/O devices and interfaces 1068 provide a communication interface to various external devices. For example, the encryption management system 130 is electronically coupled to the network 140, which may comprise one or more of a LAN, WAN, or the Internet, for example, via a wired, wireless, or combination of wired and wireless, communication link 1063. The network 140 facilitates communications among various computing devices and/or other electronic devices via wired or wireless communication links. The encryption management system may use network 140 to communicate with the application 110 and the client devices 120.

As previously shown in FIG. 1A, data from external application 110 may be sent to the encryption management system 130 over the network 140. Similarly, results may be returned over the network 140 to client devices 120. In addition to the devices that are illustrated in FIG. 3, the encryption management system 130 may communicate with other data sources or other computing devices. In addition, the data sources may include one or more internal and/or external data sources. In some embodiments, one or more of the databases, data repositories, or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

The encryption management system 130 may also include a encryption module 1050 to process encryption functionalities described herein and a template engine module 1066 to process and handle the template execution, both of which may be executed by the CPU 1090. The encryption module 1050 and the template engine module 1066 may be implemented as one or more modules, which may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Alternately, the one or both of the modules may be implemented as separate devices, such as computer servers. In alternate embodiments, the encryption management system can be implemented by multiple physical computers that are interconnected, with different encryption management functions or tasks optionally handled by different machines.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

### 10. CONCLUSION

All of the methods and processes described above may be embodied in, and fully automated via, software code modules executed by one or more general purpose computers or processors. The code modules may be stored in any type of computer-readable medium or other computer storage device. Some or all of the methods may alternatively be embodied in specialized computer hardware. In addition, the components referred to herein may be implemented in hardware, software, firmware, or a combination thereof.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A computer-implemented method for generating and sending a cryptographic key, comprising:
receiving from a server-based application a request to generate and send the cryptographic key to a client device, the request sent in a template format that includes a plurality of parameters for generating a key pair from which the cryptographic key is obtained;
executing a template for generating the key pair within a security boundary, the template comprising pre-defined data including a generation algorithm, a key size, and a plurality of key generation attributes; and
retrieving a private key in an unencrypted form from the generated key pair to be sent as the cryptographic key to the client device specified by at least one of the parameters.

2. The method of claim 1, wherein the parameters further comprise:
prefix data to the private key to be sent to the client device; and
postfix data to the private key to be sent to the client device.

3. The method of claim 2, further comprising:
combining the prefix data, the private key, and the postfix data to create a message block;
applying a secure channel algorithm encipherment associated with the client device to the message block to create a secured message block; and
sending the secured message block to the client device.

4. A computer-readable medium having stored thereon executable code which, when executed by an encryption management system, causes the encryption management system to perform the method of claim 1.

5. A computer system programmed to perform the method of claim 1.

6. A computer-implemented method for applying cryptographic functions to a message, the method comprising:
receiving a message and a plurality of parameters in a template format from an application server;
applying a template to the message, the template comprising a transform element, the transform element specifying a list of functions among which is at least one cryptographic function that applies cryptographic processing to the message; and
outputting the cryptographically processed message.

7. The method of claim 6 wherein the outputting comprises sending the cryptographically processed message to one or more client devices specified by one of the parameters.

8. The method of claim 7 wherein the sending further comprises processing the cryptographically processed message in a secure channel algorithm.

9. The method of claim 6 wherein the outputting further comprises sending the cryptographically processed message to a peer application.

10. The method of claim 6 wherein the outputting further comprises returning the cryptographically processed message to the application server.

11. The method of claim 6 wherein the functions comprise a generate key function.

12. The method of claim 6 wherein the functions comprise a wrap key function.

13. The method of claim 6 wherein the template further comprises one or more of a template name, an internal variable, an output variable, or a custom function.

14. The method of claim 13 wherein an internal variable carries the output of a function to the input of another function.

15. The method of claim 6 wherein the template is preloaded in binary form onto a secure object database.

16. An encryption management system configured to perform the method of claim 6.

17. A computer-readable medium having stored thereon executable code which, when executed by an encryption management system, causes the encryption management system to perform the method of claim 6.

18. A computer system programmed to perform the method of claim 6.

19. A encryption management system for applying cryptographic functions to a message, the encryption management system comprising:
a secure object database for storing a plurality of keys and objects; and
a template engine that causes a template to be applied, within a security boundary, to data from a calling application to create a cryptographically processed output message,
wherein the template uses the keys and objects stored in the secure object database, and
wherein the template allows cryptographic functions to be accessed by the calling application through a consistent application programming interface.

20. The encryption management system of claim 19 further comprises a secure channel engine for processing the output message before it is sent to a client device specified by the calling application.

21. The encryption management system of claim 19, wherein at least one of the functions in the application programming interface accepts as input a variable number of parameters.

22. The encryption management system of claim 19, wherein the template engine applies functions specified in the template to external parameter data, literal data, or data output from an internal template function.

23. A computer-implemented method for enchiphering and sending a cryptographic key, comprising:
receiving a request from a server application, the request being in a template format and including a plurality of parameters for enchiphering the cryptographic key; and
responding to the request by at least:
selecting a enchiphering key from a secure object database;
selecting a target key to be enchiphered;
applying a standard or custom cryptographic enchiphering algorithm to the target key using the enchiphering key;
concatenating additional message data defined in the template to the enchiphered key to create an output message;
applying a secure channel algorithm encipherment to the output message containing enchiphered key; and
sending secured message to a client device specified by at least one of the parameters.

24. A method for encrypting product design data sent to workstations in a manufacturing line, comprising:
constructing a template in response to a request to invoke the template from a workstation in the manufacturing line, the request including non-sensitive data used in the manufacturing a product device;
executing the template to generate a unique image, the unique image comprising product design data used to program the product device;
embedding a cryptographic keyset into the unique image;
encrypting the unique image with a key associated with the product device; and
sending the encrypted unique image to the workstation.

25. A method for encrypting media content distributed over a network, comprising:
receiving a request to invoke a template from a media server that has received a request for media content from a requesting device, the request comprising an authorization to distribute the media content and the media content;
executing the template, the executing further comprising:
encrypting the media content with a keyset; and
enchiphering the keyset with a unique key associated with the requesting device;
sending the encrypted media content to the requesting device; and
sending the enchiphered keyset to the requesting device to enable the requesting device to decrypt the encrypted media content.

26. The method of claim 25 wherein the keyset is retrieved from a secure object database.
